(19) United States
(12) Patent Application Publication
(10) Pub. No.: US 2010/0215018 A1
(43) Pub. Date: Aug. 26, 2010

(54) CS HANDOVER FROM IMS FEMTO TO MACRO

(75) Inventor: Richard P. Ejzak, Wheaton, IL (US)

Correspondence Address: FAY SHARPE/LUCENT, 1228 Euclid Avenue, 5th Floor, The Halle Building, Cleveland, OH, 44115-1843, US

(73) Assignee: Alcatel-Lucent USA Inc.

(21) Appl. No.: 12/393,854

(22) Filed: Feb. 26, 2009

(51) Int. Cl. H04W 36/00

(52) U.S. Cl. 370/331; 455/444

(57) ABSTRACT

Systems and methods for performing a cellular call handover from a home node b (HNB) to a macro cellular communication node (e.g., a base station or radio access network) are disclosed. An interworking function (IWF) is provided in the HNB and acts as an anchor mobile switching center (MSC) for a user device served by the HNB, and communicates with a visited MSC for the HNB. The IWF sends a request to a target MSC (which may be the visited MSC) serving the HNB, to handover the call to the macro node. The call is then handed over to the macro communication node by the target MSC. In this manner, the IWF facilitates providing the described handover in conformity with existing 3GPP standards, without requiring additional standards to be generated and without requiring additional system components.

### BACKGROUND OF THE INVENTION

The third generation partnership project (3GPP) Release 8 has introduced the concept of a femto cell, or home node b (HNB), as specified in 3GPP TS 25.467 and related specifications. The HNB provides for enhanced in-building coverage and performance in the home or enterprise. The HNB subsystem re-uses existing radio network subsystem (RNS) lu-cs and lu-ps interfaces to the circuit-switched (CS) and packet-switched (PS) core networks, respectively, to allow user equipment (UE) being served by each HNB to access all the same services provided by the CS and PS core networks.

In a separate development, 3GPP Release 8 has also introduced the concept of Internet Protocol Multimedia Subsystem (IMS) centralized services (ICS), as specified in 3GPP TS 23.292 and related specifications. Whereas normally IMS provides multimedia services to UEs using PS transport services, ICS allows the provision of IMS services to UEs accessing the network using CS procedures, thus enabling convergence of service offerings to UEs using both CS and PS services.

Due to the significant increase in call volume and call hold time expected with improved in-building coverage and performance in HNBs, there is considerable interest in providing a means of offering IMS services to CS UEs while minimizing the involvement of the CS core network. The name IMS HNB (or IMS femto) is used for this new type of HNB subsystem to indicate its significant new capabilities. The requirements driving this work in 3GPP and some proposed solutions are documented in 3GPP TR 23.832. Of the three proposed solutions presented in 3GPP as of the date of this disclosure, the biggest problem is the enablement of handover from the femto network to the macro network, which is the subject of this disclosure.

One proposed solution to the handover problem involves a combination of single radio voice call continuity (SRVCC) and service continuity (SC) procedures defined in 3GPP Release 8 and to be defined in 3GPP Release 9 in 3GPP TS 23.216 and 3GPP TS 23.237, respectively. Even with the completion of this work planned for 3GPP Release 9, there are aspects of this handover problem that are not currently in scope of the 3GPP work items. This architecture requires significant modifications to the HNB and HNB Gateway (HNB GW) (which comprise the HNB subsystem) and the presence of a new functional entity that is not otherwise needed: the mobile switching center (MSC) server enhanced for IMS HNB. This architecture further requires the development of complex new standards requiring additional invention. It has not yet been demonstrated that it is possible to achieve acceptable functionality and performance with this approach.

A second solution declares that handover/relocation is for further study. The third solution proposes the renaming and inclusion of a full 3GPP Release 8 MSC within the HNB subsystem to provide the desired functionality, which fails to meet key objectives of the work item.

One reason that the first proposed architecture has these difficulties is that the signaling plane anchor position is moved from the visited mobile switching center (V-MSC) to the HNB subsystem. Thus, it is not possible to reuse existing macro cellular circuit-switched (CS) domain handover procedures that depend on the signaling plane anchor position remaining in the V-MSC (also called the “anchor MSC” during this handover configuration).

Voice call continuity (VCC) provides a model of another system that moves the signaling plane anchor position from the packet-switched (PS) domain to the CS domain when executing a domain transfer (e.g., a new kind of “handover”). But VCC has significant limitations due to the complexity of moving complex call state (e.g., involving multiple calls, call hold, calls in progress/not stable, and calls in various states of transfer/conferencing/splitting, etc.). No means have yet been publicly described that would enable recovery of complex call state while moving the signaling plane anchor. Additionally, significant new procedures would be required to be developed to move the anchor from the HNB subsystem to the handover target system.

There is an unmet need in the art for systems and methods that resolve the above-referenced deficiencies and others.

### SUMMARY OF THE INVENTION

Systems and methods for handing off a cellular communication session from a home node b (HNB) to a macro cellular communication node are provided.

In one aspect of the invention, a system that facilitates handing over a circuit-switched (CS) user equipment (UE) call from a home node b (HNB) subsystem to a macro cellular communication node comprises an interworking function (IWF) module that communicates with the HNB, with an Internet protocol multimedia system (IMS), and with a visited mobile switching center (V-MSC) for the UE, and performs the functions of an anchor mobile switching center (MSC) for the HNB. The IWF module comprises a storage medium that stores the IWF and includes at least one processor that executes computer-executable instructions for executing one or more functions of the IWF. The IWF module sends an instruction to a target MSC with which the HNB communicates, the instruction commanding the target MSC to initiate an intersystem call handover.

According to another aspect, a method of handing over a circuit-switched (CS) user equipment (UE) call from a home node b (HNB) subsystem to a macro cellular communication node comprises providing an interworking function (IWF) that communicates with the HNB, with an Internet protocol multimedia system (IMS), and with a visited mobile switching center (V-MSC) for the UE, and performs the functions of an anchor mobile switching center (MSC) for the HNB. The method further comprises transmitting an instruction from the IWF to a target MSC with which the HNB communicates, the instruction commanding the target MSC to hand over the call. The method further comprises performing an intersystem handover of the UE call from the target MSC to the macro cellular communication node upon receipt instruction at the target MSC from the IWF.

According to another aspect, a method of providing cellular communication session handover capability for a circuit-switched (CS) user equipment (UE) from a home node b (HNB) to a macro communication node comprises providing an interworking function (IWF) in the HNB, wherein the IWF communicates with a visited mobile switching center (V-MSC) for the HNB and with an Internet protocol multimedia system (IMS), and performs the function of a traditional anchor mobile switching center (MSC). The method further comprises sending a handover instruction from the IWF in the HNB over an E-interface to a target MSC. The handover instruction triggers an intersystem handover of the cellular communication session from the target MSC to the macro communication node. The macro communication node is one of a base station subsystem (BSS) and a radio network system (RNS).

According to another aspect, a system that facilitates handover of a circuit-switched (CS) user equipment (UE) from a first radio service network (RNS) subsystem to a second RNS subsystem comprises an interworking function (IWF) module that communicates with the first RNS subsystem, with an Internet protocol multimedia system (IMS) to access services for the UE, and with a visited mobile switching center (V-MSC) for the first RNS subsystem, and performs the functions of an anchor mobile switching center (MSC) for the first RNS subsystem. The IWF module comprises a storage medium that stores the IWF and includes at least one processor that executes computer-executable instructions for executing one or more functions of the IWF. The IWF module sends an instruction to a target MSC with which the first RNS subsystem communicates, the instruction commanding the target MSC to initiate an intersystem handover of the call from the first RNS subsystem to the second RNS subsystem.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The subject innovation exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a system for performing a handover of a cellular communication link or connection from an Internet protocol multimedia subsystem (IMS) femto domain to a circuit-switched (CS) domain, in accordance with various aspects described herein.

FIG. 2 is an illustration of the system, including the components described with regard to FIG. 1, showing the paths used for signaling of the location update procedure and IMS registration.

FIG. 3 illustrates a modified call flow for performing initial IMS registration via CS Access using the systems and methods described herein.

FIG. 4 illustrates typical call control and user plane signaling paths when the UE is attached to a CS core network in the system and the UE receives the service via the CS core network, which includes all of the components as described with regard to FIG. 1.

FIG. 5 illustrates another example of call control and user plane signaling paths when the UE is attached to a CS core network in the system and the UE receives the service via IMS, which includes all of the components as described with regard to FIG. 1.

FIG. 6 illustrates a call flow for an IMS origination from a first CS UE.

FIG. 7 illustrates an IMS termination call flow to the second UE.

FIG. 8 illustrates a call flow representing a scenario in which a Visited-MSC receives a terminating SMS request while the CS UE is actively involved in an IMS service (e.g., a call termination) from within the IMS HNB.

FIG. 9 illustrates a call flow for relocation with hard handover from an IMS HNB to an RNS for a CS UE receiving IMS services from the IMS HNB.

FIG. 10 illustrates call control and user plane paths in place after the UE performs a handover/relocation from the HNB/GW-A to the BSS/RNS (FIG. 9) in the system 10, which includes all of the components as described with regard to FIG. 1.

FIG. 11 illustrates a call flow representing a scenario in which a Visited-MSC (V-MSC) receives a terminating SMS request while the CS UE is actively involved in an IMS service (e.g., a call termination) after the UE performs a handover/relocation from the HNB to the BSS/RNS.

FIG. 12 illustrates a call flow for subsequent RNS-to-HNB relocation with hard handover of the UE in an IMS session via the IWF, wherein the MSC detects a handback event.

FIG. 13 illustrates a call flow for subsequent RNS-to-HNB relocation with hard handover of the UE in an IMS session via the IWF, wherein the MSC fails to detect a handback event.

FIG. 14 illustrates the reconstruction of the original call control and user plane signaling paths after either of the two handback procedures described with regard to FIGS. 12 and 13, through the system of FIG. 1, which includes the components described with regard thereto.

FIG. 15 illustrates an intersystem call flow for a scenario involving a handover/relocation to a third MSC.

### DETAILED DESCRIPTION

This invention relates to systems and methods for handing off a circuit-switched (CS) cellular call from an Internet protocol multimedia subsystem (IMS) home node b (HNB), also called an IMS femto node, to a macro network, such as a base station subsystem (BSS) or radio network service (RNS). It will be understood that the HNB described herein is an IMS HNB.

While the invention is particularly directed to the art of cellular communication, and will be thus described with specific reference thereto, it will be appreciated that the invention may have usefulness in other fields and applications. For example, the invention may be used in communication devices, computing devices, Internet-based devices or any other wireless devices in which it is desirable to handoff a communication session or call from a femto network to a macro network (e.g., CDMA, UMTS, etc.), etc.

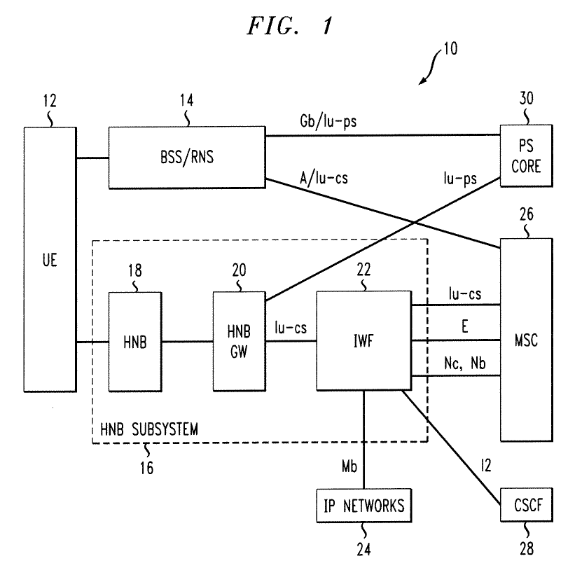

Referring now to the drawings wherein the showings are for purposes of illustrating the exemplary embodiments only and not for purposes of limiting the claimed subject matter, FIG. 1 provides an illustration of a system 10 for performing a handover of a CS cellular communication link or connection from an IMS femto domain to a circuit-switched (CS) domain, in accordance with various aspects described herein.

The system facilitates call handover from the femto domain to the macro domain by providing an interworking function (IWF) (which may be included in a home node b substation or as a standalone module that is back-portable to an existing home node b substation) that acts as an anchor mobile switching center (MSC), and communicates over the E-interface to tell a target MSC to handover the call to a radio service network or base station subsystem. While an anchor MSC usually also contains the visited location register (VLR) for a device and so is also identified by the network as the visited MSC, the herein-described IWF acts as an anchor MSC during the execution of intersystem handover/relocation procedures without also being the visited MSC for the device. The name of the IWF is likely to change if the procedures in this disclosure are subsequently standardized.

In one example, the IWF sends a request to the visited MSC to act as a target MSC as well. For instance, the IWF can send a command to the visited MSC to cause the visited MSC to additionally perform the tasks of a target MSC for a device, since the MSC does not cross-check its identity as perceived by a particular device. That is, a single MSC may act as a target MSC for a first device, as an anchor MSC for another device, and as a visited MSC for yet another device. The described innovation takes advantage of this property of the MSC by causing a single MSC to act as both a visited MSC and a target MSC for a single device, while the IWF acts as the anchor MSC for the device. By causing the visited MSC to perform the function of a target MSC, the IWF can effect the desired handoff of a device call or communication session from the home node b substation to a macro cellular node or substation.

The system 10 comprises a user equipment (UE) 12 (e.g., a cellular phone, smartphone, PDA, laptop computer, or some other personal communication or computing device), which shares a communication interface with a home node b (HNB) subsystem 16 and/or a base station subsystem (BSS) and/or radio network subsystem, collectively illustrated as BSS/RNS 14. A home node b (HNB) subsystem 16 includes an HNB 18 that is coupled to an HNB gateway (HNB GW) 20, which in turn is coupled to an interworking function (IWF) module 22 via an lu-cs interface. 3GPP TS 23.002, which is incorporated by reference in its entirety, defines all relevant interfaces and reference points, including lu-cs, lu-ps, G, A, E, Nc, Nb, Mb and I2. This disclosure uses existing standard interface names for connections to the IWF to emphasize that the functionality of these interfaces is re-used with little or no modification, even though some of the interface names may need to change during standardization, while retaining their currently defined functions, to maintain the integrity of the specifications. The IWF module 22 communicates with one or more Internet Protocol (IP) networks 24, at least one mobile switching center (MSC) 26, and at least one call session control function (CSCF) 28, which is a key element of the IMS. Communication between the IWF 22 and the IP network(s) 24 is performed over an Mb interface. Communication between the IWF 22 and the CSCF 28 is performed over an I2 interface. Communication between the IWF 22 and the MSC 26 is performed over several interfaces, including a lu-cs, Nc and Nb interfaces. The Nc interface is used for SIP communication to establish user plane connections for intersystem handover/relocation, and the Nb interface is for the corresponding user plane. Additionally, the IWF 22 communicates with an MSC 26 over an E interface, which the IWF 22 uses to transmit intersystem relocation/handover commands to the MSC 26 as if the IWF were an anchor MSC. In one example, an MSC 26 acts as a visited MSC, and the IWF 22 sends an E-interface command telling the MSC 26 to act as a target MSC as well, to effect the handover.

The system 10 additionally comprises a packet switching core 30 that communicates with the BSS/RNS 12 over a Gb or lu-ps interface and with the HBN gateway 20 over a separate lu-ps interface. Additionally, the BSS/RNS 12 communicates with an MSC 26 over an A or lu-cs interface.

It will be appreciated that one or more of the components of the system 10 include and/or are executed by and stored in respective and/or shared processing circuitry (processors) and memory for carrying out the methods and providing the functionality described herein. For instance, each component may comprise a memory or data storage medium that stores computer-executable instructions that are executed by the processor(s) to perform the function associated with the component. Additionally, the memory or data storage medium may store data that is generated, analyzed, received, transmitted, etc., by the processor(s) and/or the respective components.

The system 10 is based on the universal mobile telecommunication system (UMTS) Terrestrial Radio Access Network (UTRAN) architecture for the third-generation (3G) HNB defined in 3GPP TS 25.467, which is hereby incorporated by reference in its entirety, and which describes the HNB and HNB gateway, and the requirements for IMS HNB in 3GPP TR 23.832, which is hereby incorporated by reference in its entirety. 3GPP TS 23.002 defines the remaining network elements, except for the IWF that is described herein. The system 10 permits an unchanged or unmodified CS UE being served within an IMS HNB subsystem to access IMS services using IMS centralized services (ICS) procedures defined in 3GPP TS 23.292, which is hereby incorporated by reference in its entirety, while minimizing the involvement of elements of the CS domain, such as the MSC 26. One advantage of this innovation is that the IMS HNB offers the CS UE full service continuity for calls during which the UE moves between IMS HNB coverage and immediately adjacent macro cellular coverage (e.g., when a UE initiates a communication interface through an HNB and then subsequently moves to a macro cellular coverage area, such as a when a user places a call in his home using an HNB and then walks to his car and drives off, leaving the HNB coverage area and entering the macro coverage area).

The system thus provides the novel IWF 22, which may be part of the HNB subsystem 16 or may be stored in a standalone module that is coupled to an existing HNB. In this regard, the IWF 22 has several possible technical realizations: it can be implemented as part of the HNB GW 20; it can be a standalone node, or it can be implemented as part of a radio network system (RNS) rather than part of an HNB subsystem 16, thus providing an alternate means of providing IMS services to a UE 12 that initiates services in the macro network. The configuration option with the IMS collocated with the MSC corresponds to the MSC server enhanced for ICS defined in 3GPP TS 23.292.

In one example, the CS UE 12, BSS/RNS 14, and PS core 30 behave as they do according to existing specifications. The HNB 18 and HNB GW 20 require no changes related to standard handover procedures and may subsume some IWF functions. Other than the IWF 22, other core network nodes, such as the MSC 26, the CSCF 28, a home subscriber server (HSS) (not shown), and the IMS (not shown) need not be modified with regard to standard handover procedures. However, small changes may be implemented to some of these nodes to enable other aspects of the system.

The labeled interfaces between the components behave according to existing specifications, except that in contrast with the standards, some of them terminate at the new functional entity (i.e., the IWF), and as such their roles in the system 10 will be further explained.

The IWF 22 monitors lu-cs control plane signaling. The IWF 22 passes all non-access stratum (NAS) mobility management signaling normally tunneled between the UE 12 and the MSC 26, i.e., as occurs in the standard architecture where the HNB GW 20 is directly connected to MSC 26 via the lu-cs interface. In particular, CS attach and location update signaling passes transparently through the IWF 22. The HNB 18 is assigned a location area that is distinct from the surrounding macro areas to assure that the MSC 26 is aware of all idle mode mobility events between the HNB 18 and the macro network. Upon a successful location update, the IWF 22 performs IMS registration on behalf of the UE 12 via the I2 interface as described in 3GPP TS 23.292, to enable the UE 12 to subsequently access IMS services. The IWF 22 intercepts NAS signaling for CS call originations and terminations, identifies those to be handled within IMS rather than within the MSC 26, and interworks them with the session initiation protocol (SIP) procedures on the I2 interface towards the CSCF 28 in IMS, as defined for the MSC server enhanced for ICS in 3GPP TS 23.292. The Mb interface is the user plane interface corresponding to the I2 interface for these sessions between the IWF 22 and IMS.

The IWF 22 identifies NAS messages related to short message service (SMS), emergency services, and other calls requiring legacy CS treatment via an MSC rather than IMS, and also passes them transparently between the two lu-cs interfaces. Except for the special case described later, the IWF 22 passes incoming handover/relocation signaling on lu-cs between the MSC 26 and the remainder of the HNB subsystem 16, i.e., to support relocation of calls started in the macro network (e.g., BSS/RNS 14) into the HNB 18. For handover/relocation for calls started in the HNB subsystem 16, from the HNB 18 to the macro BSS/RNS 14 and back, the IWF 22 reuses the existing intersystem handover procedures via the E interface, as defined in 3GPP TS 23.009, which is hereby incorporated by reference in its entirety.

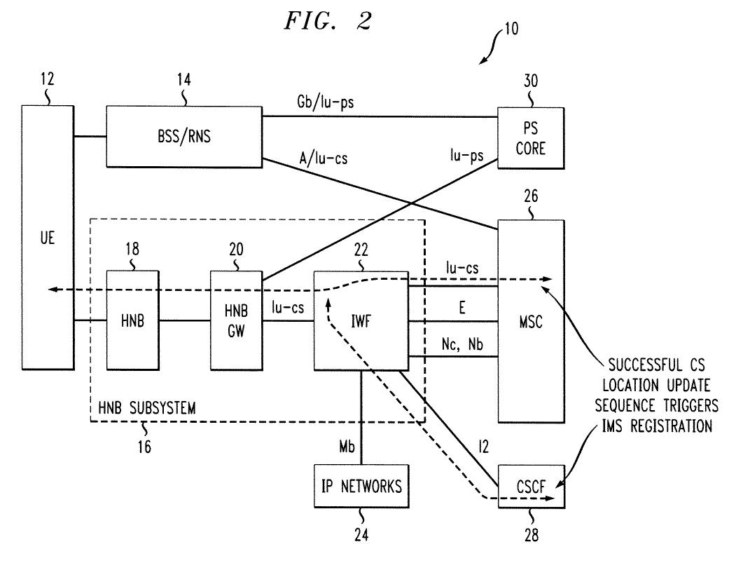

FIG. 2 is an illustration of the system 10, including the components described with regard to FIG. 1, showing the paths used for signaling of the location update procedure and IMS registration. The details of the location update and IMS registration procedures are based on the MSC server enhanced for ICS procedure defined for the I2 interface in clause 7.2.1 of 3GPP TS 23.292 and in 3GPP TS 24.292, which are hereby incorporated by reference in their entireties. As illustrated, location update signal is sent from the UE 12 to the MSC 26 via the HNB subsystem 16. When successful completion of the location update procedure is detected by the IWF 22 as the signaling is relayed to the MSC 26, the IWF 22 is triggered to send an IMS registration request to the CSCF 28 to register the UE 12 with the IMS.

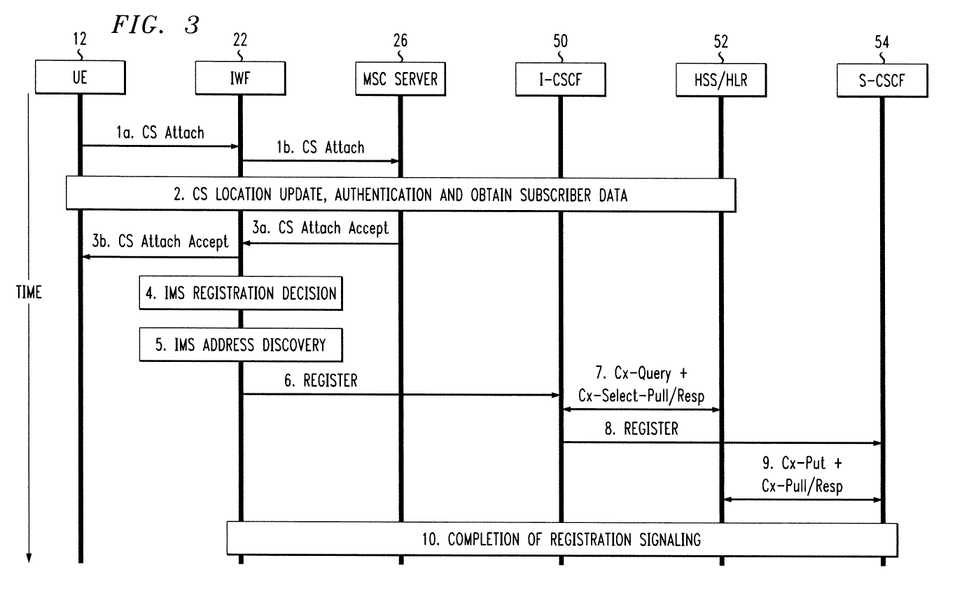

FIG. 3 illustrates a modified call flow for performing initial IMS registration via CS Access using the systems and methods described herein. Ten steps are illustrated to show communication between various components of the system 10 described herein. A CS attach signal (e.g., a location update request) is transmitted from the UE 12, through the IWF 22, to the MSC server 26. CS location update and authentication are performed, and subscriber data is obtained, across several components, including the UE 12, the IWF 22, the MSC server 26, and a home subscriber server/home location register (HSS/HLR) 52. A CS attach accept signal (e.g., a location update accept signal) is returned from the MSC server 26 to the UE 12 via the IWF 22. The IWF 22 then executes an IMS registration decision to initiate IMS registration for the UE 12, and performs IMS address discovery. Next, the IWF 22 sends a SIP REGISTER request message to the I-CSCF 50. The interrogating CSCF (i-CSCF) 50 initiates standard procedures for serving CSCF (S-CSCF) location/allocation with the HSS/HLR 52. The I-CSCF 50 then forwards the REGISTER request to a S-CSCF 54. The S-CSCF 54 then identifies the register message as being associated with an I2 interface and thus not subject to further authentication. The S-CSCF 54 may skip any further authentication procedures, and performs registration procedures with the HSS/HLR component 52. Finally, IMS registration procedures are completed across several components, including the IWF 22, the I-CSCF 50, the HSS/HLR 52, and the S-CSCF 54.

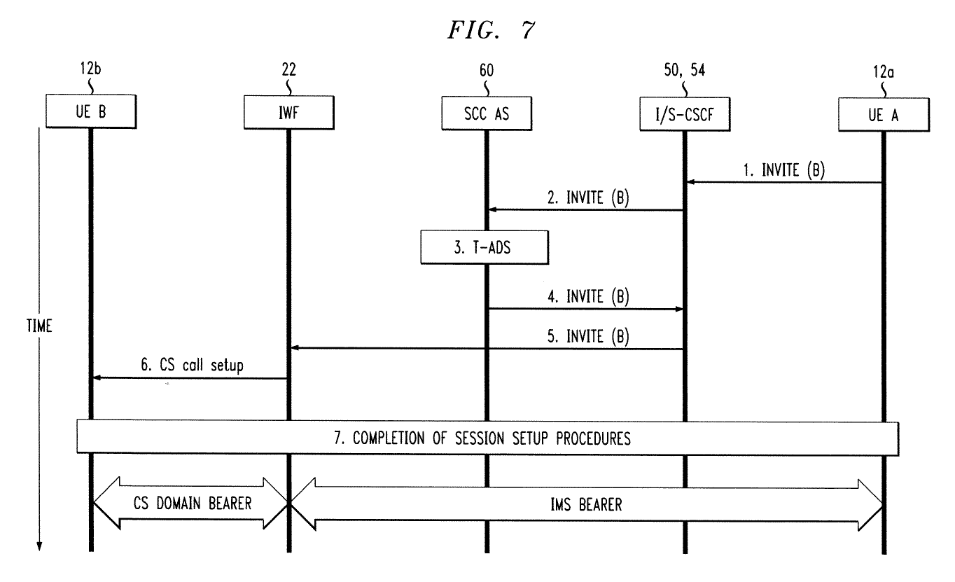

FIG. 3 thus shows a call flow similar to that of FIG. 7.2.1.2-1 of 3GPP TS 23.292. The difference between FIG. 3 and the 3GPP TS 23.292 figure is that steps 4-6 (e.g., IMS registration decision, IMS address discovery, and the creation of the SIP REGISTER request) originate in the IWF 22 based on monitoring of previous CS attach messages, rather than being performed at the MSC server. By the end of the standard location update procedure, the MSC 26 informs the IWF 22 of the international mobile subscriber identity (IMSI) of the UE 12 using the common identity procedure (not shown) on the lu-cs interface. The IWF 22 needs the IMSI to correctly generate the UE 12 identity information in the SIP REGISTER request, according to 3GPP TS 23.292. Other registration related procedures also follow 3GPP TS 23.292 in a similar way. For instance, current standards do not provide for signaling of a cancel location event on the lu-cs interface to trigger IMS de-registration at IWF 22, so other signaling may be generated to account for the cancel location event or to otherwise trigger IMS de-registration at the IWF 22.

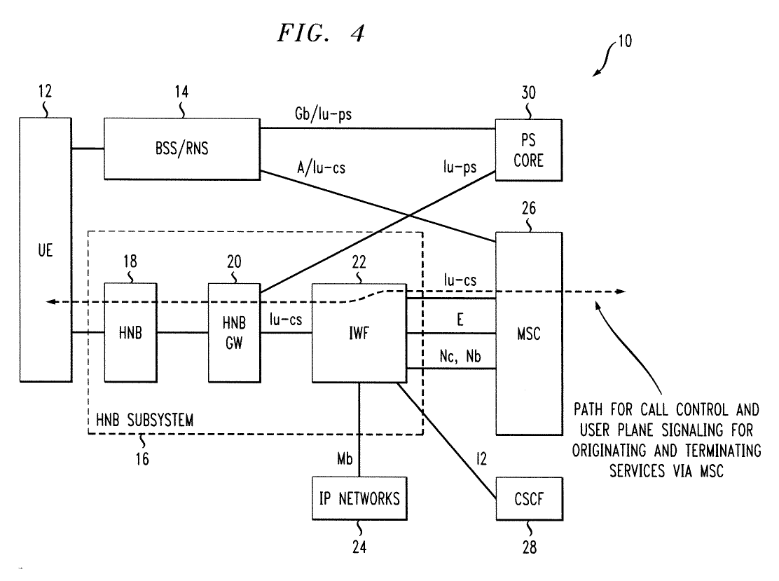

FIG. 4 illustrates typical call control and user plane signaling paths when the UE 12 is attached to a CS core network in the system 10, which includes all of the components as described with regard to FIG. 1. Note that the figure does not show nodes between the MSC 26 and the remote UE (also not shown), e.g., public switched telephone network (PSTN). Typically, the signaling is transferred between the MSC 26 and HNB GW 20 (or RNS 14) transparently according to standard procedures to realize originating and terminating CS calls and SMS (short message service), as well as to support subsequent relocation/handover procedures related to these services. These same paths are used in the IMS HNB configuration for any services not intended to be handled within IMS. Examples include SMS, emergency services, circuit switched data services, etc.

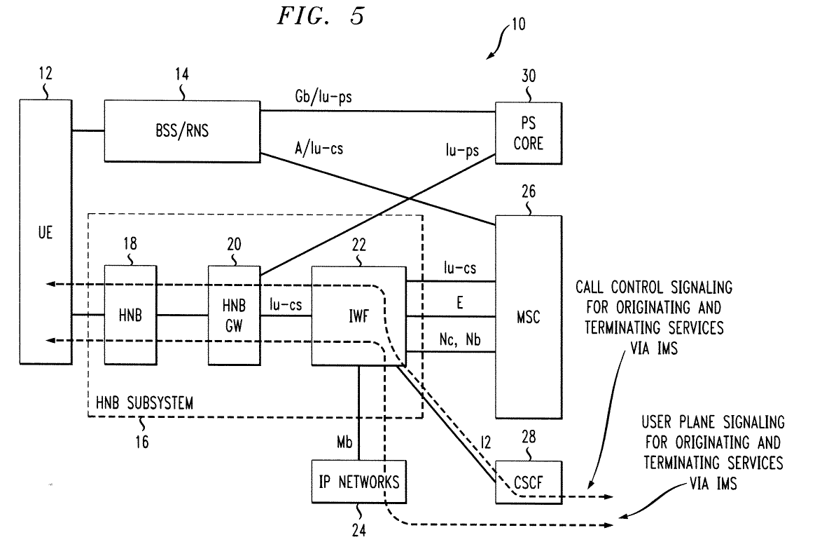

FIG. 5 illustrates another example of call control and user plane signaling paths when the UE 12 is attached to a CS core network in the system 10, which includes all of the components as described with regard to FIG. 1. Note that the figure does not show nodes between the CSCF 28 and the remote UE (not shown), e.g., other CSCFs, IMS application servers, media gateway control function (MGCF), PSTN, etc. After the IWF 22 registers the UE 12 in IMS, it is also capable of originating and terminating IMS services via the I2 interface. To do this, the IWF 22 interworks SIP signaling on the I2 interface, with the 3GPP TS 25.413 and 3GPP TS 24.008 signaling used for the lu-cs interface to the HNB GW 20 and the UE 12. This interworking can be identical to the I2 interworking defined for the MSC server enhanced for ICS in 3GPP TS 23.292 and 3GPP TS 24.292. Subsequent relocation/handover procedures related to these services require the special adaptation of standard procedures described later in this disclosure since the call control and user plane signaling are not anchored in the V-MSC 26.

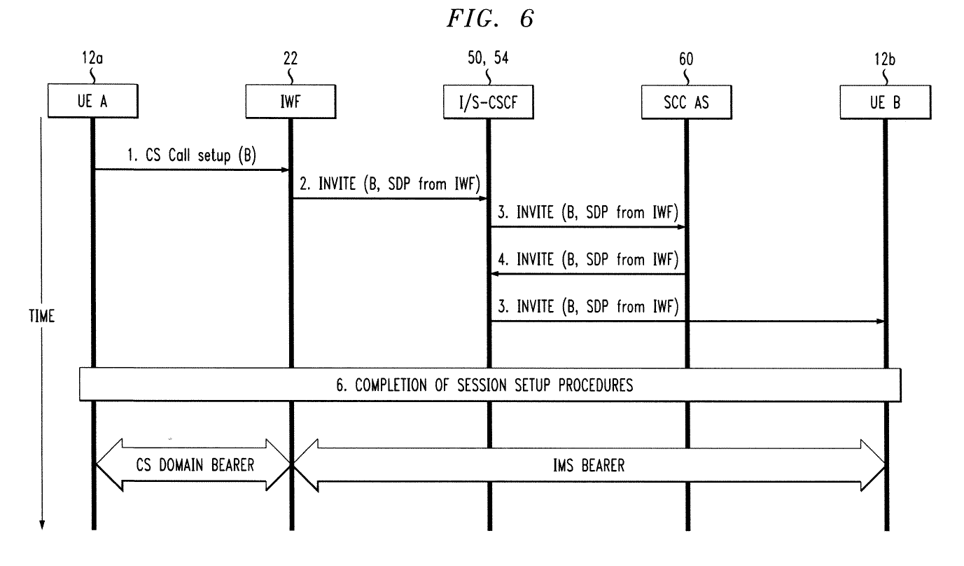

FIG. 6 illustrates a call flow for an IMS origination from a first CS UE 12a being served in the HNB 18 to a second UE 12b. Initially, the first UE 12a sends a CS call setup message containing a B-party number (e.g. a number for a second UE 12b) to the IWF 22. The IWF 22 sends a SIP INVITE request to the I/S-CSCF 50, 54 with a Request-URI set to the B-party number. The INVITE also contains session description protocol (SDP) information received from the IWF 22 that includes information needed to establish the user plane connection. The S-CSCF 54 performs standard service control execution procedures. Filter criteria direct the S-CSCF 54 to send the INVITE to the SCC AS 60. The SCC AS 60 terminates the first UE 12a leg and originates a remote leg for presentation of an IMS session towards the B-party (UE 12b) on behalf of first UE 12a. The INVITE request is routed from the SCC AS 60 to the S-CSCF 54. The S-CSCF 54 continues with standard IMS originated session processing and routes the request to the B-party (UE 12b), possibly via other entities not shown. The session and bearer control setup procedures are then completed.

Unlike the standard procedure described in FIG. 7.3.2.1.2-1 of 3GPP TS 23.292, the IWF 22 is the I2 interworking element, rather than the MSC server. 3GPP TS 23.292 provides detailed descriptions of all the nodes and messages, and is incorporated herein by reference in its entirety. For originating services, the IWF 22 monitors the signaling from the UE 12 to determine if it is intended for the I2 interface or for the MSC. The IWF 22 makes this determination based on one or more of the following: type of service requested, the priority requested, the destination or called party for the service, etc. Once the determination is made, subsequent signaling associated with that service instance is interworked exclusively to the corresponding interface. It will be appreciated that FIG. 6 does not show various signaling details that simply follow the relevant standards, in order to facilitate understanding of the embodiment described thereby.

FIG. 7 illustrates an IMS termination call flow from a first UE 12a to the second UE 12b being served in the HNB 18. Initially, an incoming INVITE is received at the S-CSCF 54 of the second UE 12b (B-party) via the I-CSCF 50 and possibly via other entities not shown. The S-CSCF 54 performs standard service control execution procedures. Filter criteria direct the S-CSCF 54 to send the INVITE to the service centralization and continuity application server (SCC AS) 60. The SCC AS 60 performs terminating access domain selection (T-ADS) to determine by which means to attempt to reach UE 12b. The SCC AS 60 chooses a CS access network and an IWF 22 contact address, from among the registered contact addresses for the second UE 12b, for the setup of the call. The SCC AS 60 establishes a new session by sending an INVITE request to the S-CSCF 54, which in turn sends an INVITE request to the IWF 22 on the contact address stored during IMS registration, using standard IMS procedures. The IWF 22 sends a CS call setup message to the second UE 12b. At this point, the session and bearer control setup procedures are completed.

FIG. 7 is thus a simplified view of a call flow showing the IWF 22 as the I2 interworking node, rather than the MSC server as shown in FIG. 7.4.2.1.2-1 of 3GPP TS 23.292. The IWF 22 interworks all IMS service termination requests and subsequent signaling related to each service instance between IMS (via CSCF 28 in FIG. 1) and the UE 12 via the HNB GW 20 (FIG. 1). It will be appreciated that FIG. 7 does not show various signaling details that simply follow the relevant standards, in order to facilitate understanding of the embodiment described thereby.

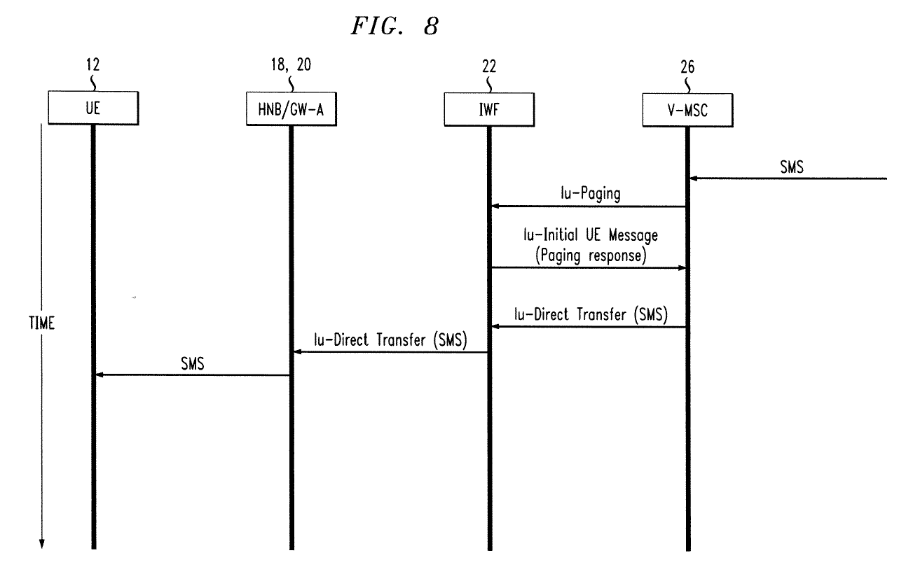

FIG. 8 illustrates a call flow representing a scenario in which a Visited-MSC (V-MSC) 26 receives a terminating SMS request while the CS UE 12 is actively involved in an IMS service (e.g., a call termination) from within the IMS HNB 18. Since the V-MSC 26 is not involved in the call control signaling for the IMS session, and does not have an lu connection established for the UE 12, it first sends a paging request toward the HNB GW 20 via the IWF 22. Since an lu connection has already been established between the HNB GW 20 and IWF 22 in support of the IMS session, there is no need for the IWF 22 to forward the paging request to the HNB GW 20. Instead, it sends a paging response message as if it were coming from the UE 12, opening an lu connection between the V-MSC 26 and IWF 22, allowing the V-MSC 26 to forward the SMS request to the UE 12 using standard procedures.

The following relocation/handover procedures assume that the UE 12 is only handling calls via the I2 interface with IMS. These procedures also support the simultaneous handling of calls via both the I2 interface towards IMS and the lu-cs interface towards MSC 26, although the figures do not show all of the call control and user plane signaling path details. These details can be readily derived from the information in this disclosure. Alternately, the IWF 22 can selectively release some service requests to avoid the simultaneous handling of calls via both the I2 and lu-cs interfaces.

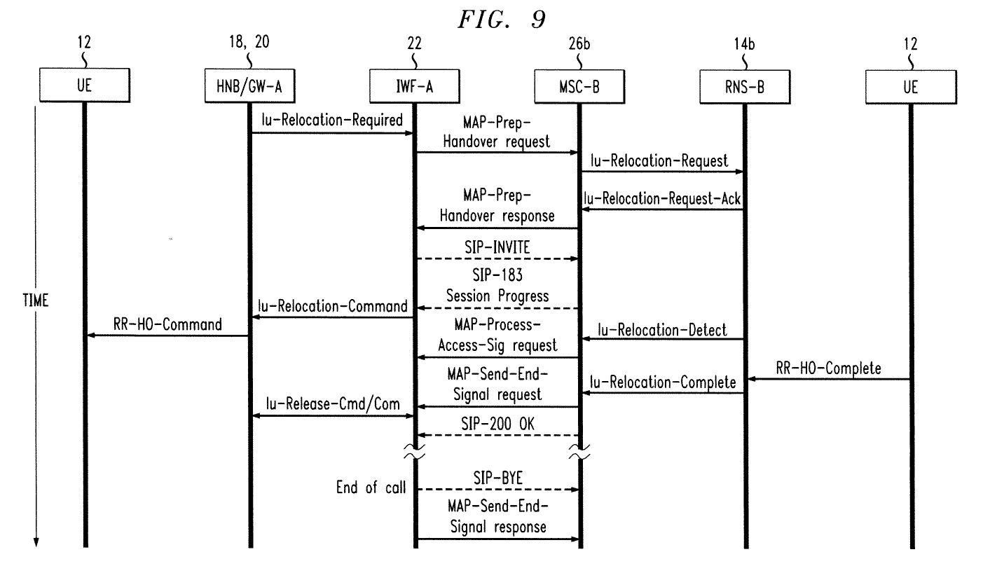

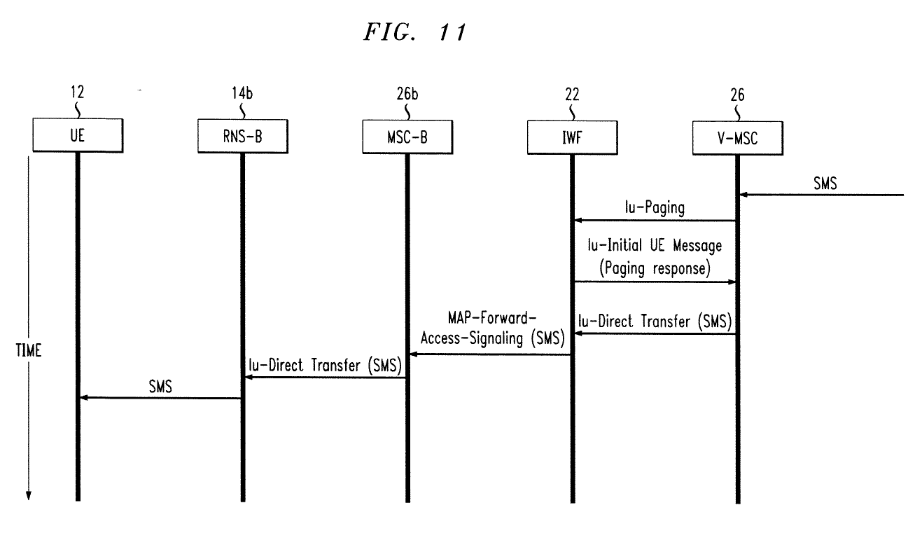

FIG. 9 illustrates a call flow for relocation with hard handover from an IMS HNB 18 to an RNS 14b for a CS UE 12 receiving IMS services via the IMS HNB. If the UE 12 is in a call served by an HNB that is being interworked with IMS via the I2 Interface at the IWF-A 22, and the HNB 18 determines that a handover to a target BSS/RNS 14b is required, it follows standard procedures to send a “relocation required” message on the lu-cs interface towards the V-MSC 26 via the IWF-A 22. The IWF-A 22 intercepts this message, and, instead of forwarding the message to the V-MSC 26 via lu, the IWF-A 22 acts as an anchor MSC in an intersystem handover/relocation procedure and sends the equivalent relocation request message via the E interface (FIG. 1) towards the target MSC-B 26b associated with the target RNS-B 14. This target MSC-B 26b may or may not be the same MSC as the V-MSC 26 for the UE 12. The remainder of the procedure follows the standard as set forth in FIGS. 11 and 30 of 3GPP TS 23.009, except that the IWF 22 plays the role of the MSC-A. 3GPP TS 23.009 is incorporated by reference in its entirety herein.

Accordingly, FIG. 9 shows that a message indicating that a relocation is required for the UE 12 is sent from the HNB/GW-A 18, 20 (e.g., the HNB 18 and HNB gateway 20) to the IWF-A 22. The IWF-A 22 and target MSC-B exchange mobile application part (MAP) messages on the E interface and session initiation protocol (SIP) messages on the Nc interface during the example procedure that follows. The IWF-A 22 sends a MAP-Prep-Handover Request to the target MSC, MSC-B 26b, which in turn sends an lu-Relocation Request to the target RNS, RNS-B 14b. The RNS-B 14b sends an acknowledgement of the lu-Relocation Request to the MSC-B 26b, which then transmits a MAP-Prep-Handover Response to the IWF-A 22. The IWF-A sends a SIP-INVITE message to the MSC-B 26b on the Nc interface to initiate establishment of a user plane connection between IWF-A 22 and target MSC-B 26b on the Nb interface to support transport of user plane media after the relocation/handover completes between the UE 12 and IP networks 24 via RNS-B 14b, MSC-B 26b and IWF-A 22. MSC-B 26b responds with the SIP-183 session progress response to the IWF-A 22.

The IWF 22 then sends an lu-Relocation Command to the HNB/GW-A 18, 20, which then sends an radio resource handover (RR-HO)-Command to the UE 12. Upon detecting radio signals from UE 12, the RNS-B 14b sends an lu-Relocation Detect signal to the MSC-B 26b, which then sends a MAP-Process-Access-Signal Request to the IWF-A 22. The UE 12 then sends an RR-HO-Complete message to the RNS-B 14b, which in turn sends an lu-Relocation Complete message to the MSC-B 26b. The MSC-B 26b sends a MAP-Send-End-Signal Request to the IWF-A 22, which then exchanges lu-Release-Command/Complete messages with the HNB/GW-A 18, 20 to release their lu connection. MSC-B 26b also sends a SIP 200 OK response to IWF-A 22 to complete establishment of the user plane connection. Note that the Nc and Nb interfaces may interchangeably use the call control and user plane signaling associated with the integrated services digital network user part (ISUP), bearer independent call control (BICC), or SIP protocols. SIP messages are shown on the Nc interface as an example rather than the ISUP messages shown in FIG. 30 of 3GPP TS 23.009.

Upon termination of the call, the IWF-A 22 sends a SIP termination message (SIP-BYE request) to the MSC-B 26b, and a MAP-Send-End-Signal Response to the MSC-B 26b.

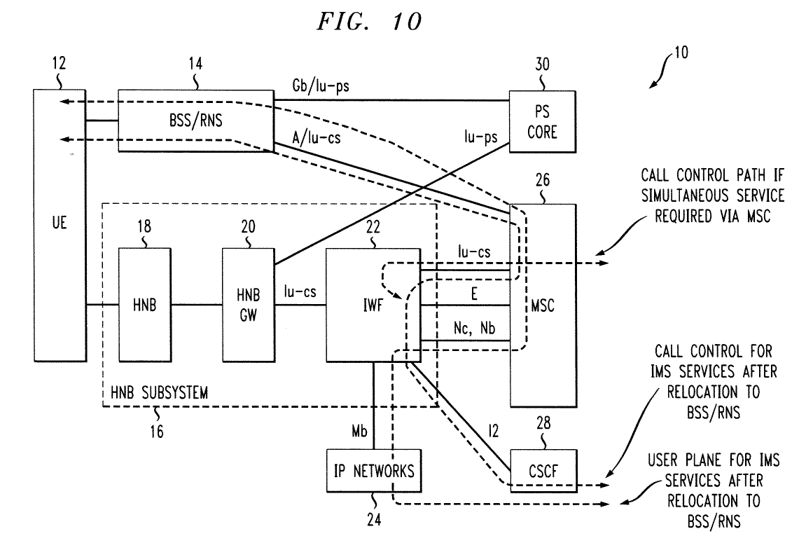

FIG. 10 illustrates call control and user plane paths in place after the UE 12 performs a handover/relocation from the HNB/GW-A 18, 20 to the BSS/RNS 14b (FIG. 9) in the system 10, which includes all of the components as described with regard to FIG. 1. During the standard intersystem handover/relocation procedure shown in FIG. 9, (with corresponding paths shown in FIG. 10) the IWF-A 22 (acting as anchor MSC) and target MSC-B 26b (MSC 26) establish an NAS signaling path for call control between the UE 12 and the IWF 22 via the target RNS-B 14b (BSS/RNS 14), target MSC-B 26b (MSC 26), and the E interface. In FIG. 10, the IWF 22 and target MSC 26 (analogous to MSC-B 26b of FIG. 9) also establish the user plane path between the UE 12 and the IWF 22 via the target BSS/RNS 14, target MSC 26 and Nc/Nb interfaces according to standard procedures as defined in 3GPP standards.

While in a stable intersystem handover/relocation configuration between the IWF 22 and target MSC 26, the IWF 22 performs interworking between the call control and user plane signaling on the E, Nc and Nb interfaces from the target MSC 26, towards the corresponding I2 and Mb interfaces towards IMS, analogous to an MSC server enhanced for ICS in a similar intersystem handover/relocation configuration.

While in this stable intersystem handover/relocation configuration, any NAS signaling originating from or destined towards the V-MSCNLR 26 (which has not changed from before the handover/relocation procedure) is interworked between the lu-cs interface (between the IWF 22 and V-MSCNLR 26) and the E interface (between the IWF 22 and target MSC 26). Note that if the V-MSCNLR 26 and target MSC 26 are the same MSC, as shown in FIG. 10, then the MSC 26 performs both functions independently since there is no requirement for the target MSC to cross-check against its VLR for incoming handover/relocation signaling for a UE, and the target MSC does not require any VLR data to perform its function for the UE 12. Otherwise MSC 26 may represent two different MSCs performing the functions of the V-MSCNLR and target MSC, respectively.

There are additional considerations for terminating requests from the V-MSCNLR 26 via the lu-cs interface while the network is in a stable intersystem handover/relocation configuration and the target BSS/RNS 14 is reachable from the V-MSCNLR 26. Since the V-MSC/VLR function of MSC 26 is unaware that the UE 12 is on channel in this state and is unaware that the UE 12 is on channel in a reachable BSS/RNS, it assumes that paging is needed. The paging need only be directed to the HNB 18 in this case, and the paging message need not directly reach the target/serving BSS/RNS 14 from the V-MSC 26. The V-MSC 26 pages the UE 12 in the currently registered location area (via IWF 22) so that the IWF 22 can either immediately respond to the page or forward it to the UE 12 via the E interface, as appropriate.

FIG. 11 illustrates a call flow representing a scenario in which a Visited-MSC (V-MSC) 26 receives a terminating SMS request while the CS UE 12 is actively involved in an IMS service (e.g., a call termination) after the UE 12 performs a handover/relocation from the HNB 18 to the BSS/RNS 14b.

The scenario begins when the V-MSC 26 receives a terminating SMS request for UE 12. Since the V-MSC function in MSC 26 handles the terminating SMS request and is unaware of the target MSC-B 26b relocation function potentially being performed in the same MSC 26 for the UE 12, the V-MSC function in the MSC 26 is not involved in the call control signaling for the IMS session. Thus, the V-MSC function of MSC 26 sends a paging request toward the IWF 22 via the lu-cs interface. Since the target MSC-B 26b function has already established an lu connection for the UE 12 between the MSC 26b and RNS 14b in support of the IMS session, there is no need for the IWF 22 to forward the paging request to the target MSC-B 26b function via the E interface. Instead, it sends a paging response message as if it were coming from the UE 12, opening an lu connection between the V-MSC function of MSC 26 and IWF 22, allowing the V-MSC function to forward the SMS request to the UE via the IWF 22, E interface, target MSC 26b and RNS 14b using standard procedures.

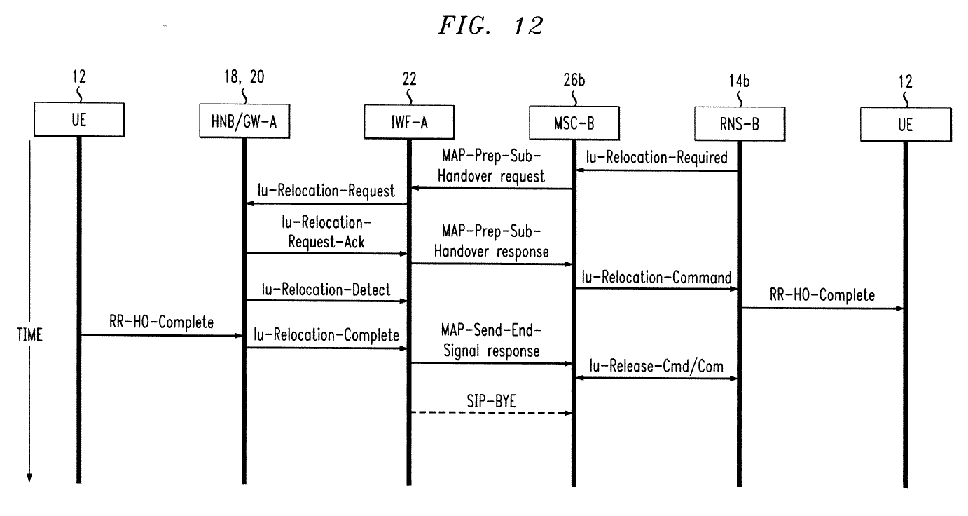

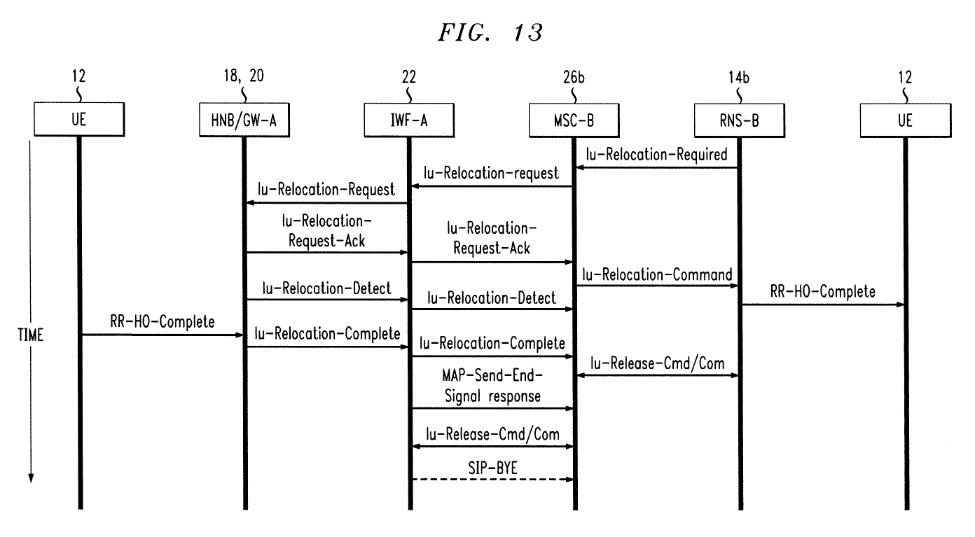

FIGS. 12 and 13 illustrate two possible call flows for addressing a scenario in which an intersystem handback procedure occurs during a stable intersystem handover/relocation configuration for a call with IMS interconnection via IWF 22. FIG. 12 illustrates a call flow for subsequent RNS-to-HNB relocation with hard handover of the UE 12 in an IMS session via the IWF 22, wherein the target MSC 26b detects a handback event. FIG. 13 illustrates a call flow for subsequent RNS-to-HNB relocation with hard handover of the UE 12 in an IMS session via the IWF 22, wherein the target MSC 26b fails to detect a handback event. Note that procedures enabling handover/relocation towards any HNB are still subject to standardization of some details but do not impact the extensions described in this disclosure.

According to FIG. 12, if a UE 12 is being served by RNS-B 14b and the RNS-B 14b determines that handover/relocation of the UE 12 to HNB 18 is required, the RNS-B 14b sends an lu-Relocation-Required message to the MSC-B (target MSC) 26b according to standard procedures. Recognizing that this is a handback scenario requiring relocation back to the IWF-A 22 (identified as the anchor MSC for the call by the target MSC 26b), the MSC-B 26b then sends a MAP-Prep-Sub-Handover Request via the E interface to the anchor IWF-A 22, which in turn sends an lu-Relocation Request to the anchor HNB/GW-A 18, 20. The HNB/GW-A 18, 20 returns an lu-Relocation-Request-acknowledgement to the IWF-A 22, which sends a MAP-Prep-Sub-Handover response to the MSC-B 26b. The MSC-B 26b sends an lu-Relocation Command to the RNS-B 14b, which then sends an RR-HO-Command to the UE 12. Upon detecting radio signals from UE 12, the HNB/GW-A 18, 20 sends an lu-Relocation Detect command to the IWF-A 22, after which the UE 12 sends an RR-HO-Complete signal to the HNB/GW-A 18, 20 upon completion of the relocation. The HNB/GW-A 18, 20 sends an lu-Relocation complete message to the IWF-A 22, which then sends a MAP-Send-End-Signal response to the MSC-B 26b. The MSC-B 26b and RNS-B 14b exchange lu-Release-Command/Complete messages to release their lu connection, and the IWF-A 22 terminates the SIP session via SIP termination message (SIP-BYE).

The call flow follows the intersystem handback scenario described in FIG. 32 of 3GPP TS 23.009 (hereby incorporated by reference) with the addition of the hard handover signaling described in FIG. 11 of 3GPP TS 23.009.

When complete, the procedure of FIG. 12 reconstructs the call control and user plane configuration (i.e., FIG. 5) that existed prior to the first handover/relocation procedure (i.e., FIG. 9), when the UE 12 was served by the HNB 18.

In FIG. 13, if a UE 12 is being served by RNS-B 14b and the RNS-B 14b determines that handover/relocation of the UE 12 to HNB 18 is required, the RNS-B 14b sends an lu-Relocation-Required message to the MSC-B 26b. If the MSC-B 26b does not recognize this as a handback scenario requiring the use of the E interface and instead simply recognizes the IWF 22 and HNB 18 as the “target RNS” for a standard intrasystem relocation scenario, the MSC-B 26b will apply the standard intrasystem relocation procedure. The MSC-B 26b sends an lu-Relocation-Request via the lu-cs interface to the IWF-A 22, which in turn sends or forwards the lu-Relocation-Request to the HNB/GW-A 18, 20. The HNB/GW-A 18, 20 returns an lu-Relocation-Request-acknowledgement to the IWF-A 22, which forwards the acknowledgement to the MSC-B 26b, which in turn issues an lu-Relocation command to the RNS-B 14b. The RNS-B 14b then issues an RR_HO command to the UE 12.

The HNB/GW-A then sends an lu-Relocation-Detect command to the IWF-A 22, which forwards the command to the MSC-B 26b. When the relocation is complete, the UE 12 issues an RR-HO-Complete indication or message to the HNB/GW-A 18, 20, which sends an lu-Relocation-Complete message to the IWF-A 22, which in turn sends or forwards the lu-Relocation-Complete message to the MSC-B 26b. The MSC-B 26b and RNS-B 14b exchange lu-Release-Command/Complete messages to release their lu connection. The IWF-A 22 sends a MAP-Send-End-Signal response to the MSC-B 26b, upon which the MSC-B 26b and the IWF-A 22 exchange lu-Release-Command/Complete messages to release their lu connection. The IWF-A 22 then terminates the SIP session via SIP termination message (SIP-BYE).

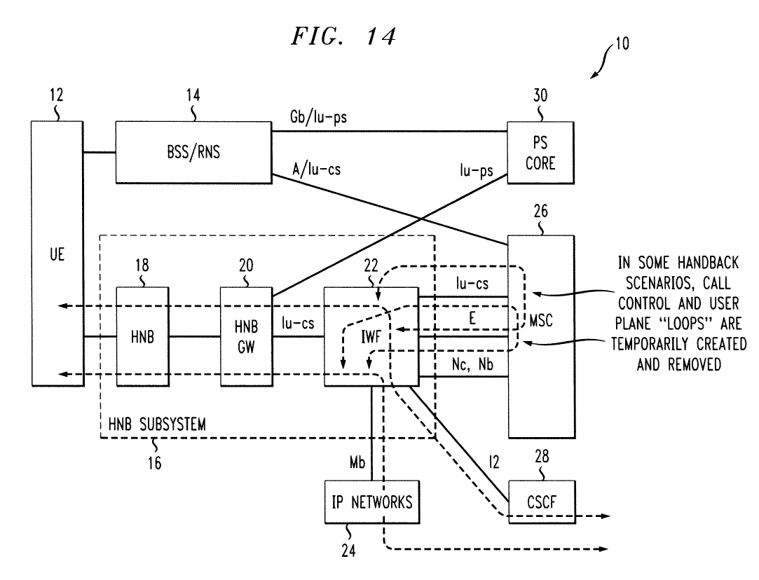

The call flow follows the intrasystem relocation scenario described in FIG. 11 of 3GPP TS 23.009, but with the addition of the MAP-Send-End-Signal response message from the IWF to the MSC after the relocation procedure is complete, which triggers the release of the E, lu, Nc and Nb resources between the IWF 22 and MSC 26b, as detailed in FIG. 14 and described below. When complete, the procedure of FIG. 13 reconstructs the call control and user plane configuration (i.e., FIG. 5) that existed prior to the first handover/relocation procedure (i.e., FIG. 9), when the UE 12 was served by the HNB 18.

FIG. 14 illustrates the reconstruction of the original call control and user plane signaling paths after the handback procedure described with regard to FIG. 13, through the system 10 of FIG. 1, which includes the components described with regard thereto. FIG. 14 shows the temporary call control and user plane “loops” created through the MSC during the handback procedure of FIG. 13.

During the procedure of FIG. 13, the MSC-B 26b temporarily creates call control and user plane signaling “loops” via the E, Nc, Nb and lu-cs interfaces between itself and the IWF 22. This occurs when the MSC-B 26b does not recognize it as a handback scenario requiring the use of the E interface. Thus during the course of the handover/relocation procedure, the target MSC-B 26b assumes that it needs to separately maintain and interwork the call control and user plane signaling paths towards the IWF 22 (acting as “anchor MSC”) via the E, Nc and Nb interfaces on the one hand, and towards the IWF 22 (acting as “target BSS/RNS”) via the lu-cs interface on the other hand. The IWF 22 detects the “loops” when the handover procedure completes and immediately reinstates the original call control and user plane configuration that existed prior to the first handover/relocation procedure (i.e., FIG. 5), releasing the handover/relocation loops created with the invoking MSC 26b.

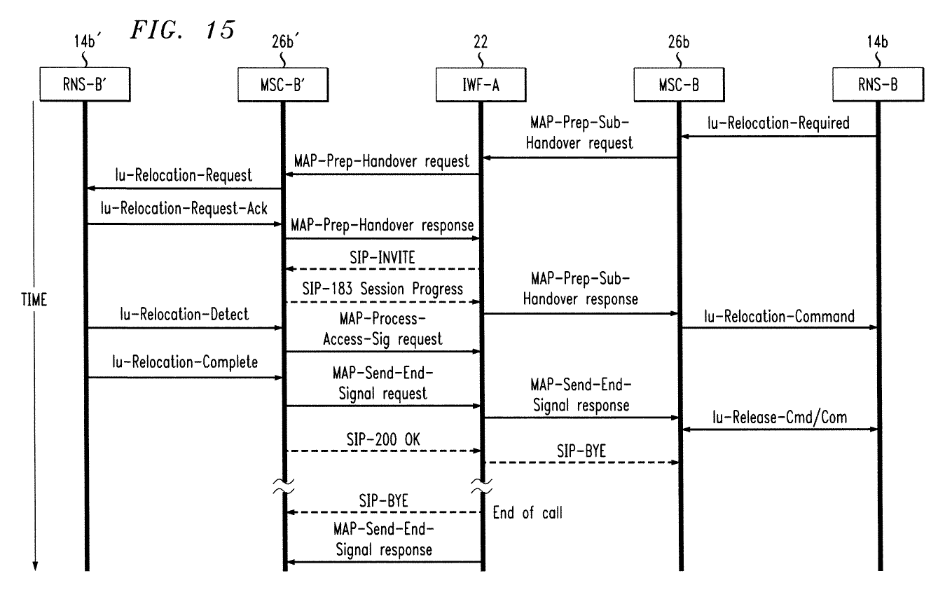

FIG. 15 illustrates an intersystem call flow for a scenario involving a handover/relocation to a “third” MSC (MSC-B′) 26b′. The scenario is similar to that described in the standard at FIG. 33 of 3GPP TS 23.009 (incorporated herein by reference in its entirety), except that the IWF 22 performs the role of the MSC-A described in the standard.

In FIG. 15, if a UE 12 is being served by RNS-B 14b and the RNS-B 14b determines that handover/relocation of the UE 12 to a new RNS-B′ 14b′ is required, the RNS-B 14b sends an lu-Relocation-Required message to the MSC-B 26b, which then sends a MAP-Prep-Sub-Handover Request to the IWF-A 22 via the E interface. The IWF-A 22 sends a MAP-Prep-Handover Request to the MSC-B′ 26b′, which then sends an lu-Relocation-Request to a new BSS/RNS, RNS-B′ 14b′. The RNS-B′ 14b′ returns an lu-Relocation-Request-Acknowledgement to the MSC-B′ 26b′, which then sends a MAP-Prep-handover response to the IWF-A 22. To initiate establishment of the Nb user plane connection between the IWF-A 22 and MSC-B′ 26b′, the IWF-A 22 sends an SIP-INVITE request via the Nc interface to the MSC-B′ 26b′, which sends a SIP-183 Session Progress response to the IWF-A 22. The IWF-A 22 then sends a MAP-Prep-Sub-Handover Response to the MSC-B 26b, which sends an lu-Relocation Command to the RNS-B 14b. Signaling may or may not be needed at this point with the UE 12 to facilitate the handover/relocation to RNS-B′ 14b′. When radio connectivity is established with UE 12, the RNS-B′ 14b′ then sends a Relocation-Detect message to the MSC-B′ 26b′. The MSC-B′ 26b′ then sends a MAP-Process-Access-Signal request to the IWF-A 22.

When the relocation procedure is completed, the RNS-′ 14b′ sends an lu-Relocation-Complete message to the MSC-B′ 26b′, which then sends a MAP-Send-End-Signal request to the IWF-A 22. The IWF-A 22 sends a MAP-Send-End-Signal response to the MSC-B 26b, which then exchanges lu-Release-Command/Complete messages with the RNS-B 14b, to release their lu connection for the UE 12. The MSC-B′ 26b′ then completes the establishment of the user plane connection between the MSC-B′ 26b′ and IWF-A 22 by sending the SIP 200 OK response to IWF-A 22. The IWF-A 22 then terminates the previous SIP connection with the MSC-B 26b (SIP-BYE).

When the call is terminated, the IWF-A 22 sends a SIP-BYE message to the MSC-B′ 26b′, and then sends a MAP-Send-End-Signal message to the MSC-B′ 26b′.

A previously stated, the herein-described systems, call flows, etc., include and/or are executed by one or more processors and associated memory components or data storage mediums that store computer-executable instructions for providing the described functionality and performing the described actions.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

We claim:

1. A system that facilitates handing over a circuit-switched (CS) user equipment (UE) call from a home node b (HNB) subsystem to a macro cellular communication node, comprising:
an interworking function (IWF) module that communicates with the HNB, with an Internet Protocol Multimedia Subsystem (IMS) to access services for the UE, and a visited mobile switching center (V-MSC) for the UE, and performs the functions of an anchor mobile switching center (MSC) for the HNB;
wherein the IWF module comprises a storage medium that stores the IWF and includes at least one processor that executes computer-executable instructions for executing one or more functions of the IWF; and
wherein the IWF module sends an instruction to a target MSC with which the HNB communicates, the instruction commanding the target MSC to initiate an intersystem handover of the call.

2. The system of claim 1, wherein the V-MSC is the target MSC.

3. The system of claim 1, wherein the IWF module executes an Internet Protocol Multimedia System (IMS) registration decision whereby the IWF determines that the UE requires an IMS connection.

4. The system of claim 3, wherein the IWF module discovers an address of the IMS.

5. The system of claim 4, wherein the IWF module transmits a session initiation protocol (SIP) register message to a call session control function (CSCF) module to initiate registration of the UE with the IMS.

6. The system of claim 1, wherein the IWF module transmits the instruction to the target MSC over an E-interface connection.

7. The system of claim 1, wherein the IWF module is integral to the HNB.

8. The system of claim 1, wherein the IWF module is a stand-alone module that is communicatively coupled to the HNB.

9. The system of claim 1, wherein the UE is at least one of a cellular phone, a smartphone, wireless computing device, and a personal desktop assistant (PDA).

10. The system of claim 1, wherein the macro cellular communication node is at least one of a base station subsystem (BSS) and a radio network subsystem (RNS).

11. A method of handing over a circuit-switched (CS) user equipment (UE) call from a home node b (HNB) subsystem to a macro cellular communication node, comprising:
providing an interworking function (IWF) that communicates with the HNB, with an Internet Protocol Multimedia Subsystem (IMS), and with a visited mobile switching center (V-MSC) for the UE, and performs the functions of an anchor mobile switching center (MSC) for the HNB;
transmitting an instruction from the IWF to a target MSC with which the HNB communicates, the instruction commanding the target MSC to handover the call; and
performing an intersystem handover of the UE call from the IWF to the target MSC and the macro cellular communication node upon receipt instruction at the target MSC from the IWF.

12. The method of claim 11, further comprising:
executing an Internet Protocol Multimedia System (IMS) registration decision whereby the IWF determines that the UE requires an IMS connection;
discovering an address of the IMS; and
transmitting a session initiation protocol (SIP) register message from the IWF to a call session control function (CSCF) module to initiate registration of the UE with the IMS.

13. The method of claim 11, further comprising transmitting the instruction from the IWF to the target MSC over an E-interface connection.

14. The method of claim 11, wherein the IWF module is integral to the HNB.

15. The method of claim 11, wherein the IWF module is a stand-alone module that is communicatively coupled to the HNB.

16. The method of claim 11, wherein the UE is at least one of a cellular phone, a smartphone, wireless computing device, and a personal desktop assistant (PDA).

17. The method of claim 11, wherein the macro cellular communication node is at least one of a base station subsystem (BSS) and a radio network subsystem (RNS).

18. A method of providing cellular communication session handover capability for a circuit-switched (CS) user equipment (UE) from a home node b (HNB) to a macro communication node, comprising:
providing an interworking function (IWF) in the HNB, wherein the IWF communicates with an Internet Protocol Multimedia Subsystem (IMS) and with a visited mobile switching center (V-MSC) for the HNB and performs the function of a traditional anchor mobile switching center (MSC); and
sending a handover instruction from the IWF in the HNB over an E-interface to a target MSC;
wherein the handover instruction triggers an intersystem handover of the cellular communication session from the IWF to the target MSC and the macro communication node;
wherein the macro communication node is one of a base station subsystem (BSS) and a radio network system (RNS).

19. The method of claim 18, wherein the cellular communication session is executed over at least one of a code-division multiple access (CDMA) communication protocol and a universal mobile telecommunications system (UMTS) communication protocol.

20. A system that facilitates handover of a circuit-switched (CS) user equipment (UE) from a first radio service network (RNS) subsystem to a second RNS subsystem, comprising:
an interworking function (IWF) module that communicates with the first RNS subsystem, with an Internet protocol multimedia system (IMS) to access services for the UE, and with a visited mobile switching center (V-MSC) for the first RNS subsystem, and performs the functions of an anchor mobile switching center (MSC) for the first RNS subsystem;
wherein the IWF module comprises a storage medium that stores the IWF and includes at least one processor that executes computer-executable instructions for executing one or more functions of the IWF; and
wherein the IWF module sends an instruction to a target MSC with which the first RNS subsystem communicates, the instruction commanding the target MSC to initiate an intersystem handover of the call to the second RNS subsystem.
